(19) United States
(12) Patent Application Publication
(10) Pub. No.: US 2025/0342538 A1
(43) Pub. Date: Nov. 6, 2025

(54) System and Method for Estimating Intrinsic Popularity of Content

(71) Applicant: Northern Lights Post, Inc., New York, NY (US)

(72) Inventors: Mohammad Reza Rajati, Los Angeles, CA (US); Mark Littman, New York, NY (US); David Gioiella, Darien, CT (US); Mohammad Yavarimanesh, San Diego, CA (US)

(21) Appl. No.: 19/199,846

(22) Filed: May 6, 2025

Related U.S. Application Data
(60) Provisional application No. 63/642,980, filed on May 6, 2024.

(51) Int. Cl. G06Q 50/00; G06V 10/44; G06V 10/74; G06V 10/764

(52) U.S. Cl. CPC G06Q 50/01; G06V 10/44; G06V 10/761; G06V 10/764

(57) ABSTRACT

A computer-implemented method for estimating a popularity likelihood of an input content before the input content is posted onto a social media platform. Feature vectors of the input content are extracted and compared with feature vectors of known popular contents and with feature vectors of known unpopular contents. A predetermined number of nearest neighbors of the known popular and unpopular contents are determined using a similarity calculator. The popularity likelihood of the input content is based, at least in part, on the number of the nearest neighbors that are known popular contents relative to the predetermined number of the nearest neighbors.

### CROSS-REFERENCE TO RELATED APPLICATIONS

This application claims priority to U.S. Provisional Application No. 63/642,980, filed on May 6, 2024, titled “System and Method For Estimating Intrinsic Popularity Of Content,” which is hereby incorporated by reference.

### TECHNICAL FIELD

This disclosure relates to online content and assessment of popularity thereof.

### BACKGROUND

The Internet, World Wide Web, and other online and data network environments provide important means for posting, sharing, uploading, downloading, and commenting on content. The content is often provided by an account user through a social media application or platform where other users of the application or platform can experience and access the content. Such content is often visual and/or audio media content such as photographs, artwork, videos, music, and so on (generally herein “content”). Persons sharing, uploading, or publishing content are often the original authors or creators of the content, but this is not necessarily the case. Persons sharing content may also be users or agents having access to an account on a given social media platform. The content can be made accessible to a limited audience such as friends or other subscribers of a platform, groups of users, etc. The content may alternatively be available publicly to large numbers of people so long as they have the means to experience, view or download the content in whatever format is required in each instance. While content sharing is majorly done on social media, the scope of this invention is not limited to the intrinsic popularity of content shared on social media and can apply to any content shared on any type of media.

Content sharing has become a widespread method for promotion. Promotion of content can be explicitly promoting sales of commercial products and services (e.g., advertising, and related promotions). Content sharing may also seek to promote political, social, or other causes and agendas. Content sharing may additionally be used to increase the exposure of a group or individual or an actual or aspiring celebrity. Some platforms or social media applications reward content creators or publishers for attracting the attention of viewers, which increases public attention to the platform and to the content, and consequently, to any promotional or advertising opportunities associated with the content or the account sharing the content. Some platforms and content sharing application providers pay content creators and publishers for the success of their content, accounts, or channels in attracting large audiences, exceeding certain numbers of viewers, followers, or other engagement by the public. Therefore, content owners or promoters can be highly motivated to increase audience engagement with the content that is shared. It is thus important for persons, groups, companies or parties that have an interest in audience engagement by content to understand what makes a given content likeable, engaging, seen, interesting, i.e., “popular.” Typically, a content creator or channel or account that shares popular content acquires a larger number of regular audience members, subscribers, or “followers.” Following such a creator, publisher, account or channel enhances the engagement between a follower user and the publishing user. Following also commonly includes receiving notifications sent from the content creator account or channel to the platform or application users and members that follow said creator, account, or channel. Additionally, many social media applications and platforms permit followers or general audience members to post reactions, responses, questions, comments, “like” indications of liking the content, etc. to a comments section associated with the content and/or the account or channel. Very popular content creators or publishers are sometimes called “influencers” on account of their supposed ability to influence people and trends by way of the volume of their followers. In some cases, companies or organizations retain and hire influencers to benefit from the public efforts possible to promote products and services through social media platforms and accounts of such influencers, sometimes using discount codes associated therewith. Therefore, this ability is of great interest to those purveying goods, services, ideologies, lifestyles, or other agendas.

Popularity of content on the internet, and in particular social media, depends on many variables, some of which is not directly related to the content. For example, the popularity of content may depend on the time of sharing it, what is going on in the world at the time of sharing, and the characteristics of the person or entity that shares it. In an example, content shared by a celebrity is more likely to be popular than content shared by an ordinary person. In another example, content shared about Thanksgiving is more likely to become popular when it is the Thanksgiving season.

Some of the characteristics of a content publisher that may affect popularity of content on the internet and social media are the number of followers of the publisher, the level of activity of the publisher on an application or platform (e.g., number of posts of the publisher on Instagram), the platform on which the publisher shares the content (there are inherent differences between Facebook, Instagram, YouTube, Pinterest, Flicker, Twitter (n/k/a X), and TikTok and the type of content that is popular on them), and the type of content the publisher usually shares. In a hypothetical example, a food influencer may receive many more likes on the content they share than a tech influencer.

Understanding and quantifying the popularity or likeability of content is therefore of interest in many fields. Such understanding can further allow the creators and publishers of content to tailor or optimize their content to increase its popularity and engagement with a specific or general audience. Many applications and platforms such as social media outlets provide a numerical indicator of the number of views, followers, and similar metrics to gauge popularity of content. However, this is generally available after the content has been created, edited, and uploaded to the given platform. Since it can be costly to generate high quality and popular content, it is desired that the creator determines or anticipates or estimates the popularity of content before it is finalized and shared. Currently there is a lack of effective means to usefully identify, determine or advise in the creation and selection of content that would be popular.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a computer-implemented method for estimating a popularity likelihood of an input image before the input image is posted onto a social media platform, the method comprising feeding the input image into a trained machine learning (ML) model running on a computer, the trained ML model configured to extract a plurality of feature vectors from the input image; extracting, with the trained ML model, the feature vectors from the input image; identifying, using the feature vectors and a similarity calculator running on the computer, a predetermined number of nearest neighbors of sample images, the sample images having a known detrended popularity metric, the sample images including known popular images having a known detrended popularity percentile that is greater than a 50th percentile and known unpopular images where the known detrended popularity percentile is less than or equal to the 50th percentile; and predicting, with the computer, the popularity likelihood of the input image based, at least in part, on a number of the nearest neighbors that are known popular images relative to the predetermined number of the nearest neighbors.

In one or more embodiments, the popularity likelihood is determined as a ratio of the number of the nearest neighbors that are known popular images relative to the predetermined number of the nearest neighbors. In one or more embodiments, the similarity calculator includes as inputs the feature vectors of the input image and feature vectors of the sample images.

In one or more embodiments, the method further comprises feeding the sample images into the trained ML model; and extracting, with the trained ML model, the feature vectors of the sample images from the sample images. In one or more embodiments, the method further comprises comparing, with a large language model (LLM), the feature vectors of the input image and the feature vectors of the known popular images; and producing, with the LLM, recommendations based on the comparison.

In one or more embodiments, the recommendations include narrative text that describes one or more recommended changes to the input image. In one or more embodiments, the recommendations include a new image that includes one or more recommended changes to the input image.

In one or more embodiments, the computer is a first computer, and the method further comprises receiving the input image from a second computer in network communication with the first computer. In one or more embodiments, the method further comprises capturing the input image with a camera coupled to and/or in communication with the second computer.

Another aspect of the invention is directed to a computer-implemented method for estimating a popularity likelihood of a sequential input content before the sequential input content is posted onto a social media platform, the method comprising with a decomposer running on a computer, decomposing the sequential input content into a plurality of frames; feeding the frames into a trained machine learning (ML) model running on the computer, the trained ML model configured to extract a plurality of feature vectors from each frame; extracting, with the trained ML model, the feature vectors from each frame; applying, with the computer, a sequential model to the feature vectors of the frames; and predicting, using a probability classifier running on the computer, the popularity likelihood of the sequential input content using the sequential model of the sequential input content and sequential models of a plurality of sequential sample contents, each sequential sample content having a known detrended popularity metric, the sequential sample content including a plurality of known popular sequential contents having a respective known detrended popularity percentile that is greater than a 50th percentile and a plurality of known unpopular sequential contents where the respective known detrended popularity percentile is less than or equal to the 50th percentile.

In one or more embodiments, the sequential input content comprises a video content or an audio content. In one or more embodiments, the probability classifier determines a predetermined number of the sequential sample contents as nearest neighbors, and the popularity likelihood of the sequential input content is based, at least in part, on a number of the nearest neighbors that are known popular sequential content relative to the predetermined number.

In one or more embodiments, the popularity likelihood is determined as a ratio of the number of the nearest neighbors that are known popular sequential content relative to the predetermined number. In one or more embodiments, the method further comprises decomposing, with the decomposer, the sequential sample contents into respective frames; feeding the respective frames of the sequential sample contents into the trained ML model; extracting, with the trained ML model, a plurality of feature vectors from each frame of each sequential sample content; and applying, with the computer, a respective sequential model to the respective feature vectors of the frames for a respective sequential sample content to produce the sequential models.

In one or more embodiments, the computer is a first computer, and the method further comprises receiving the sequential input content from a second computer in network communication with the first computer. In one or more embodiments, the sequential input content comprises a video, and the method further comprises capturing the video with a camera coupled to and/or in communication with the second computer.

In one or more embodiments, the sequential input content comprises an audio file, and the method further comprises capturing the audio file with a microphone coupled to and/or in communication with the second computer.

Another aspect of the invention is directed to a system for estimating a popularity likelihood of an image prior to posting the image onto a social media platform, comprising a camera configured to capture an input image to be uploaded to the social media platform; a first computer comprising one or more first microprocessors; a first non-volatile memory operably coupled to the microprocessor(s), the first non-volatile memory storing first computer-readable instructions that when executed by the first microprocessor(s), cause the first microprocessor(s) to run an application for uploading the input image to a popularity predictor; a second computer comprising one or more second microprocessors; a second non-volatile memory operably coupled to the second microprocessor(s), the second non-volatile memory storing second computer-readable instructions that, when executed by the second microprocessor(s), cause the second microprocessor(s) to receive the input image from the application running on the first computer; feed the input image into a trained machine learning (ML) model that is configured to extract a plurality of feature vectors from the input image; extract, with the trained ML model, the feature vectors from the input image; identify, using the feature vectors and a similarity calculator, a predetermined number of nearest neighbors of sample images, the sample images having a known detrended popularity metric, the sample images including known popular images having a known detrended popularity percentile that is greater than a 50th percentile and known unpopular images where the known detrended popularity percentile is less than or equal to the 50th percentile; predict the popularity likelihood of the input image based, at least in part, on a number of the nearest neighbors that are known popular images relative to the predetermined number of the nearest neighbors; and send an output representing the popularity likelihood to the application running on the first computer.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a flow chart of a computer-implemented method for estimating a popularity likelihood of an unposted content before the content is posted onto a social media platform according to one or more embodiments.

FIG. 2 shows a system for estimating a popularity likelihood of an unposted content before the content is posted onto a social media platform according to one or more embodiments.

FIG. 3 shows a system for estimating a popularity likelihood of an unposted content before the content is posted onto a social media platform according to one or more alternative embodiments.

FIG. 4 shows a system for producing recommendations to enhance an unposted content according to one or more embodiments.

FIG. 5 illustrates an example system and method for processing recommendations to a user using a large language model according to one or more embodiments.

FIG. 6 is a flow chart of a computer-implemented method for estimating a popularity likelihood of unposted sequential content before the sequential content is posted onto a social media platform according to one or more embodiments.

FIG. 7 is a system for estimating a popularity likelihood of unposted sequential content before the sequential content is posted onto a social media platform according to one or more embodiments.

FIG. 8 is a system for estimating a popularity likelihood of unposted sequential content before the sequential content is posted onto a social media platform according to one or more alternative embodiments.

FIG. 9 is a system for estimating a popularity likelihood of unposted sequential content before the sequential content is posted onto a social media platform according to one or more alternative embodiments.

FIG. 10 is a block diagram of a system and method for determining a detrended popularity of content on a social media platform(s).

FIG. 11 is a block diagram of a system and method for training a model to predict a popularity likelihood of input content.

FIG. 12 is a block diagram of a computer system according to one or more embodiments.

FIG. 13 is a block diagram of a computer system according to one or more embodiments.

### DETAILED DESCRIPTION

Feature vectors of an unposted content are extracted using a trained machine-learning (ML) model. A similarity calculator compares the feature vectors of the unposted content are features vectors of known popular contents and known unpopular contents to determine a predetermined number of nearest neighbors of known popular and unpopular contents. The predicted popularity of the unposted content is based, at least in part, on the number of nearest neighbors of known popular contents relative to the predetermined number. The known popular contents have a detrended popularity in at least the upper 50th percentile. The known unpopular contents have a detrended popularity in at most the lower 50th percentile.

In one or more embodiments, one or more recommendations can be provided based on a comparison of the unposted content and a plurality of exceptionally popular contents that have a detrended popularity in at least the 90th percentile. The recommendations can include summaries of recommended changes and/or generated content that incorporates the recommended changes.

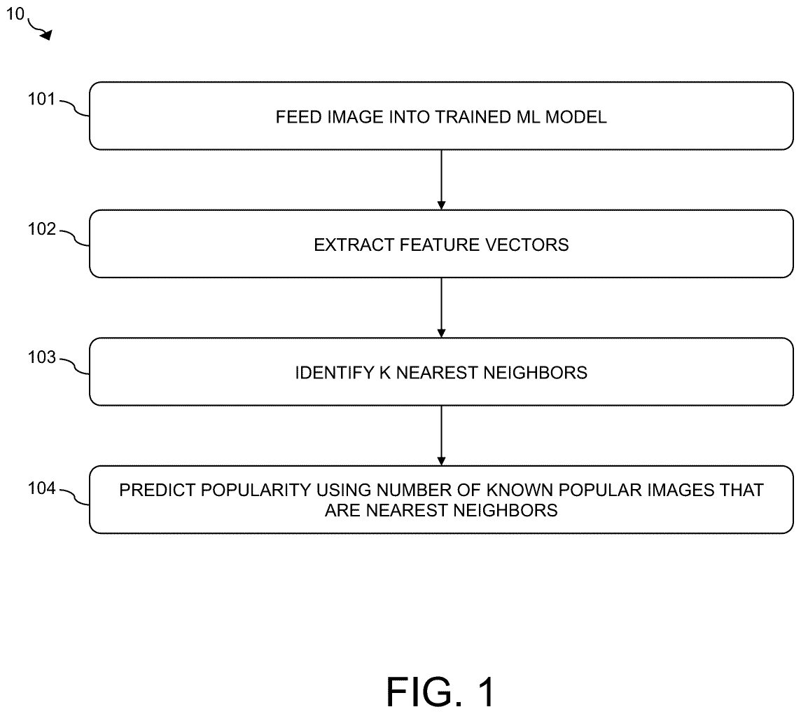

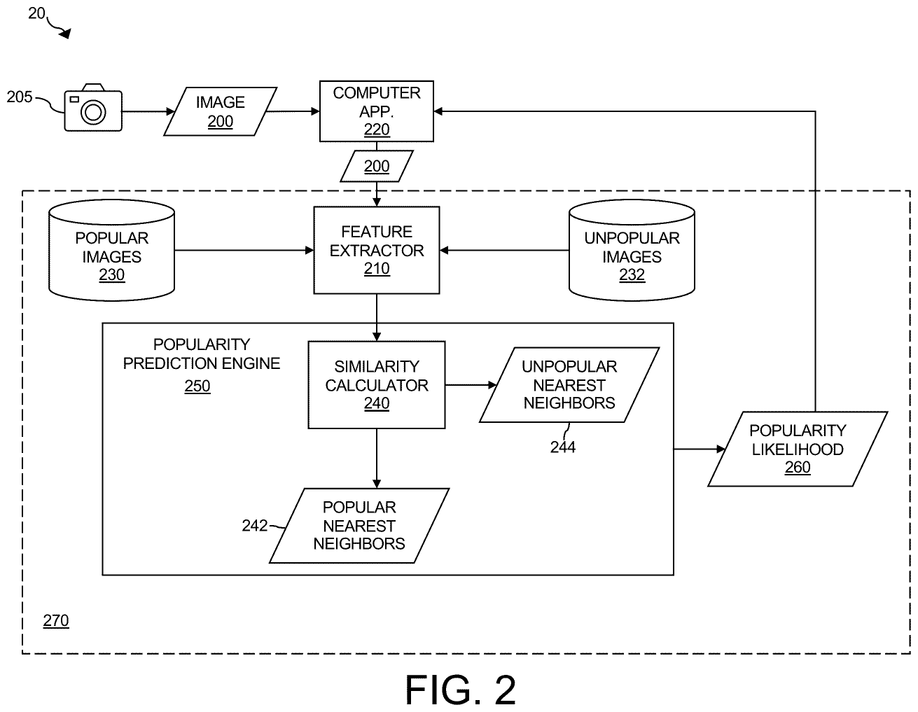

FIG. 1 is a flow chart of a computer-implemented method 10 for estimating a popularity likelihood of an unposted image before the image is posted onto a social media platform according to one or more embodiments. Method 10 can be performed using system 20 shown in FIG. 2.

In step 101, an input image 200 is fed into a trained ML model that is configured to extract features (e.g., feature vectors) from the input image 200. The input image 200 can alternately be referred to as an unposted image (e.g., that has not been posted to a social media platform or network). Examples of a social media platform or network include Facebook, Snapchat, Instagram, Pinterest, Flicker, Twitter (n/k/a X), Bluesky, and TikTok. The trained ML model can comprise a feature extractor 210. Examples of the feature extractor 210 and/or the trained ML model can include a convolutional neural network (CNN) and/or a recurrent CNN (RCNN) such as ResNet 50, ResNet 100, VGG 16, VGG 19, EfficientNet, Clip, or another CNN/RCNN. A trained ML model other than a CNN/RCNN can be used in some embodiments. The feature extractor 210 can run on one or more computers 270. The computer(s) 270 can include one or more servers, one or more laptops, one or more desktops, and/or other computer(s).

The input image 200 can be captured using a digital camera 205 such as a webcam, a smartphone, or another digital camera. The input image 200 can be uploaded or provided to the feature extractor 210 using a computer application 220. The computer application 220 can include a web browser or another application running on a computer (e.g., a smartphone or another computer such as a laptop, a desktop, a tablet, etc.). Additionally or alternatively, the input image 200 can be created, generated, and/or edited on a computer. For example, the input image 200 can include a digital photograph that has been edited or postprocessed by applying masks, crops, color correction, background changes, etc. In another example, the input image 200 includes computer graphics such as a cartoon or a meme.

The feature extractor 210 is also configured to extract features (e.g., feature vectors) from a plurality of known popular images 230 and from a plurality of known unpopular images 232. The known popular images 230 have a detrended popularity in the upper 50th percentile including the 60th percentile, the 70th percentile, the 80th percentile, the 90th percentile, or any value or range between any two of the foregoing values. In one or more embodiments, known popular images 230 having a detrended popularity in the 90th percentile or higher (e.g., 90th percentile to 99th percentile including any value. or range between any two of the foregoing values) can be referred to as known exceptionally popular images. A detrended popularity accounts for the number of followers of the person or people (e.g., social media account(s)) that posted the known popular images 230. The known unpopular images 232 have a detrended popularity in the lower 50th percentile including the 40th percentile, the 30th percentile, the 20th percentile, the 10th percentile, or any value or range between any two of the foregoing values. The known popular images 230 and the known unpopular images 232 can be stored in the same or separate non-volatile computer memory, such as in a database, of the computer(s) 270.

In step 102, the feature vectors of the input image 200, the known popular images 230, and the known unpopular images 232 are extracted using the feature extractor 210. The feature vectors include or are numerical transformations of the input images or videos to a vector of numerical elements that are not necessarily interpretable by humans. They encode characteristics of the input such as edges, colors, shapes, objects, and/or themes in a way that input images that are semantically close have feature vectors that are close in mathematical sense. For example, the image of an apple will have a feature vector that is closer to the feature vector of an image of a tangerine than to the feature vector of an image of a house. Likewise, the feature vector of a video about cleaning a bathroom will be closer to the feature vector of a video of cleaning a kitchen than to the feature vector of a video of wildlife. This is usually done by training large scale Deep Neural Networks with tremendous amounts of data, enabling them to be able to make such meaningful transformations. In particular, a deep neural network is trained to classify images in a large dataset such as ImageNet, or a transformer is trained on a large-scale video-text pairs. Once training is complete, the weights in the deep model are frozen, and the so-called logits which are outputs of the layer before the SoftMax or outputs of a few layers before are used as feature vectors extracted from the asset, which can be text, image, video, or even sound. There are numerous models for extracting such features from assets, including ResNet50, ResNet 100, Clip, xClip, SigLip, Google Gemini, among others. The space in which these feature vectors are represented is sometimes called a latent space or embedding space.

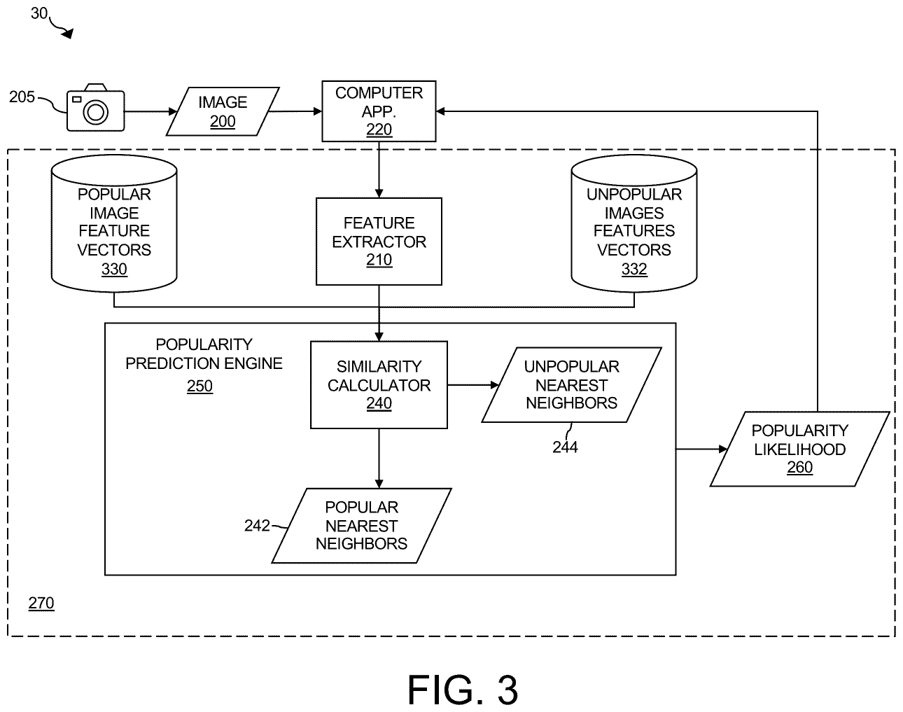

Alternatively, the feature vectors of the known popular images 230 and the known unpopular images 232 can be extracted previously, as shown in system 30 in FIG. 3. System 30 is the same as system 20 except that the known popular images 230 and the known unpopular images 232 in system 20 are preprocessed by the feature extractor 210 or another feature extractor. Thus, system 30 includes known popular image feature vectors 330 and known unpopular image feature vectors 332 instead of known popular images 230 and known unpopular images 232, respectively. The known popular image feature vectors 330 and known unpopular image feature vectors 332 are coupled to the input of a similarity calculator 240. The similarity calculator 240 can run on the computer(s) 270.

In step 103, a predetermined number (e.g., K) of nearest neighbors of the input image 200 are identified and/or determined. The predetermined number of nearest neighbors can be identified or determined using a similarity calculator 240. The similarity calculator 240 can include and/or implement a K nearest neighbors (KNN) model that can compare the feature vectors of the input image 200 to the feature vectors of the known popular images 230 and the known unpopular images 232. The output of the similarity calculator 240 includes a number N of known popular image nearest neighbors 242 and a number M of known unpopular image nearest neighbors 244.

KNN is a valid predictive model if it can label unseen test data correctly, significantly more than 50% of the time in an exemplary instance (which is of course generalizable as mentioned). In an embodiment, to determine the pertinent value of K a validation set approach and/or cross-validation can be used.

In one or more embodiments, KNN can be implemented using a cosine similarity measure between a feature vector of the input image 200 a feature vector of each labeled images (e.g., a feature vector of a known popular image 230 or a feature vector of a known unpopular images 232) according to Equation 1:

$$cosine similarity = \frac{〈 {v}^{′} , {v}_{i} 〉}{\sqrt{〈 {v}^{′} , {v}^{′} 〉 \times 〈 {v}_{i} , {v}_{i} 〉}} \qquad ( 1 )$$

where v′ is a feature vector of the input image 200 and vᵢ is a feature vector of a labeled image (e.g., a feature vector of a known popular image 230 or a feature vector of a known unpopular images 232 depending on which label image is being compared to the input image 200).

The input image 200, the known popular images 230, and the known unpopular images 232 can be of the same image type. For example, the input image 200, the known popular images 230, and the known unpopular images 232 can all be or include digital photographs. In another example, the input image 200, the known popular images 230, and the known unpopular images 232 can all be or include computer graphics such as cartoons or memes.

In step 104, a predicted popularity likelihood 260 of the input image 200 is determined based, at least in part, on the number of the number N of known popular image nearest neighbors 242 relative to the predetermined number (e.g., K) of the nearest neighbors that were determined in step 103. For example, the predicted popularity likelihood 260 can be determined according to Equation 2.

$$Predicted Popularity Likelihood = \frac{N}{K} \times 100 \% \qquad ( 2 )$$

The predicted popularity likelihood 260 can be calculated using a popularity prediction engine 250. The popularity prediction engine 250 can include the similarity calculator 240 or can be separate from the similarity calculator 240. The popularity likelihood 260 can be provided to the user that provided the input image 200, for example by sending the predicted popularity likelihood 260 back to the computer application 220. Additionally or alternatively, the predicted popularity likelihood 260 can be provided to the user through email, text message, an alert, a pop-up, and/or other electronic communication means. The predicted popularity likelihood 260 can be provided numerically (e.g., as the percentage calculated in Equation 2) or as a binary “popular” or “unpopular.” The input image 200 can be classified as popular when the predicted popularity likelihood calculated in Equation 2 is more than 50% (e.g., 51% to 100%), e.g. if most of the nearest neighbors are known popular images 230. The input image 200 can be classified as unpopular when the predicted popularity likelihood is less than or equal to 50% (e.g., 0% to 500%) e.g. if most of the nearest neighbors are known unpopular images 232.

This process can classify unlabeled content (e.g., input image 200) better than randomly. Thus valuable information about the popularity of a piece of content in its K-nearest neighbors in the feature space created by pretrained models such as ResNet 50 and xClip for static images and videos (e.g., moving images), respectively. ResNet50 and xClip are provided only as examples, but those skilled in the art can substitute or modify these examples as appropriate for a given purpose. Any process that suits an application can be employed including those given herein by way of example such as ResNet100, VGG16, VGG19, EfficientNet, Clip, and/or others.

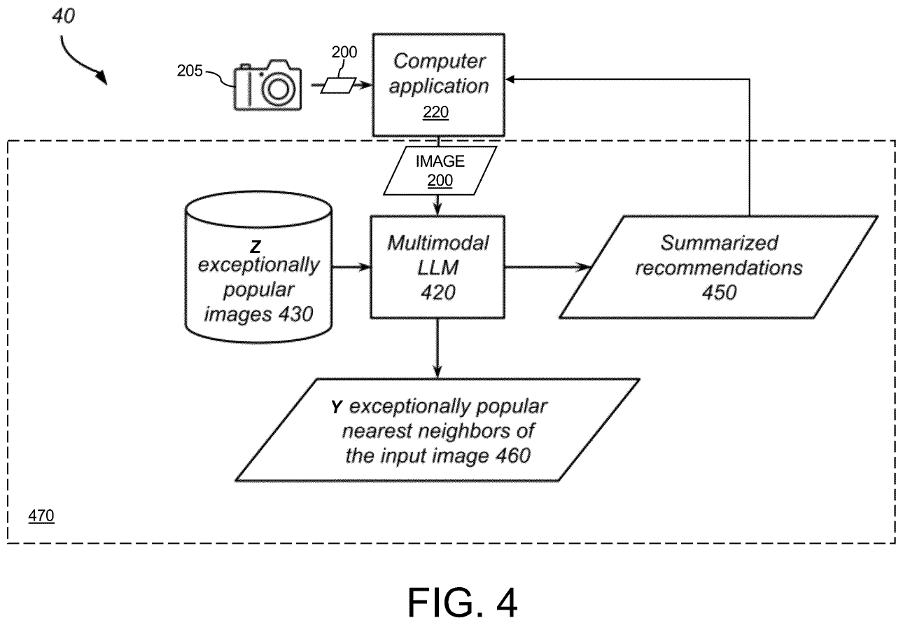

Enhancement of content (e.g., making it more likely to be popular or increasing its engagement) is thus made possible using the present system and method. Based on the ability of the similarity calculator 240 (e.g., KNN) to predict or help predict popularity, we may extract knowledge found in very popular contents to enhance the probability of content becoming more popular in some embodiments. For example, to detect the most intrinsically popular content, we may choose the top X % of the image in terms of a detrended intrinsic popularity score, which can be referred to as an “exceptionally popular” dataset. The top X % can comprise the top 10% (the 90th percentile), the top 5% (the 95th percentile), the top 1% (the 99th percentile), or any value or range between any two of the foregoing values. From this point we may choose the Z pieces of content in the exceptionally popular dataset (e.g., Z exceptionally popular images 430 shown in system 40 in FIG. 4) that are the most similar to an input image 200 we wish to enhance. A multimodal large-language model (LLM) 420 can receive as inputs the Z exceptionally popular images 430 and the input image 200. The multimodal LLM 420 can receive multiple forms of input such as image, text, video, audio, and/or other inputs. Example of the multimodal LLM 420 include a Large Language and Vision Assistant (LLaVA) or a Generative Pre-trained Transformer (GPT) such as ChatGPT.

The multimodal LLM 420 compares the Z exceptionally popular images 430 and the input image 200 and produces as an output recommendations 450 for changes to the input image 200 to improve (e.g., increase) the predicted popularity likelihood 260 of the input images 200. The multimodal LLM 420 can determine the recommendations 450 by determining or identify a predetermined number (e.g., Y) of exceptionally popular images 460 that are the nearest neighbors to the input image 200. The multimodal LLM 420 can use a similarity calculator such as similarity calculator 240 for example to determine a cosine similarity (Equation 2) between feature vectors of the input image 200 and feature vectors of the Z exceptionally popular images 430) to find the most similar Y of them to the input, i.e. the nearest neighbors. In one or more embodiments, the multimodal LLM 420 can use a general-purpose content comparison algorithm to detect the differences between the input content and the Y exceptionally popular nearest neighbors 460 in the dataset. The recommendations 450 can comprise narrative text that describes one or more recommended changes, enhancements, and/or modifications (e.g., recommending that a person in an image smile) to improve the likelihood the input image 200 will be popular (e.g., to improve its predicted popularity likelihood). Additionally or alternatively, the recommendations 450 can include textual, graphical, and/or audio modifications of the input image 200 to create one or more new images that include recommended changes, enhancements, and/or modifications to the input image 200 to improve the likelihood the input image 200 will be popular (e.g., to improve its predicted popularity likelihood). For example, instead of or in addition to including a written (text) recommendation that a person in an image smile, the recommendations 450 can include a new image in which the person is the image is smiling. The recommendations 450 can be provided to the user that provided the input image 200, for example by sending the recommendations 450 back to the computer application 220. Additionally or alternatively, the recommendations 450 can be provided to the user through email, text message, an alert, a pop-up, and/or other electronic communication means.

The multimodal LLM 420 can run on one or more computers 470. The computer(s) 470 can be the same or different than the computer(s) 270. The exceptionally popular images 430 can be stored in non-volatile memory on the computer(s) 470.

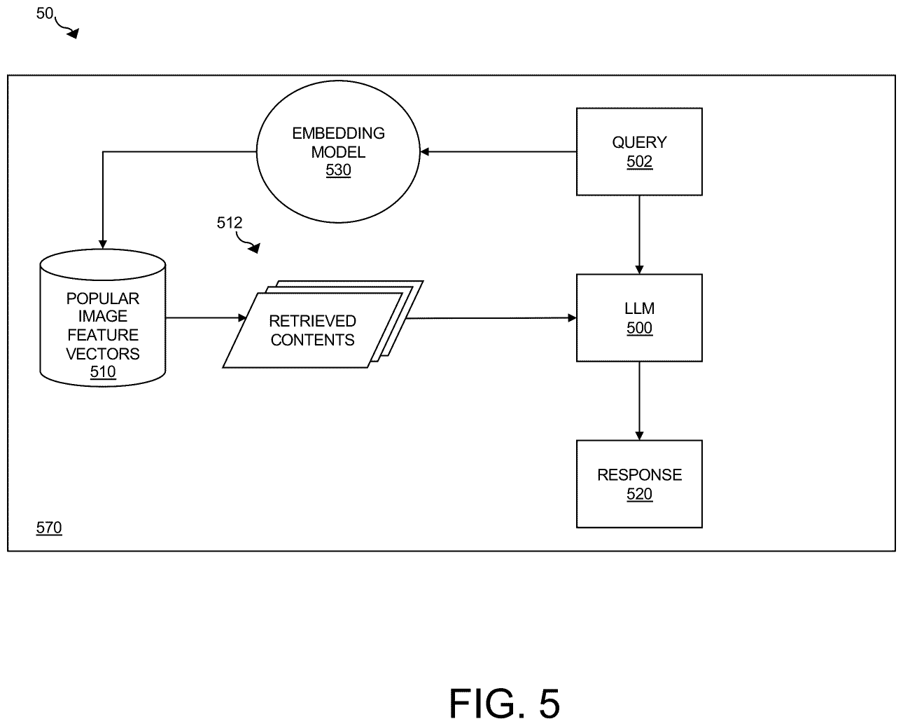

FIG. 5 illustrates an example system and method 50 for processing recommendations to a user (human or machine) using an LLM 500. In an aspect of using LLMs to issue recommendations, Retrieval Augmented Generation (RAG) or similar approaches for augmenting the knowledge in the LLM with objective world knowledge and data can be used to distill the knowledge about interestingness, attractiveness, and popularity of content. In particular, a multimodal LLM such as Clip or Gemini encodes content, and in some embodiments, exceptionally popular content such as text, image, sound, and video, into a shared vector space. In some embodiments, contrastive training can be used to train such multimodal LLM models. A vector database 510 such as Qdrant, Pinecone, Weaviate, or FAISS can be used to ingest feature vectors extracted from an embedding model 530. The embedding model 530 is configured to extract feature vectors from an image, video, and/or text input. In one or more embodiments, the embedding model 530 can be the same as a feature extractor 210 (FIG. 2). The vector database 510 can efficiently handle any multimodal input query, even if there are billions of such embeddings. A query 502 (e.g., a text and/or another query) can be used as an input regarding content enhancement as well as any form of content such as text, audio, image, or video. The query 502 is used to search the vector database 510 to instantly retrieve relevant search results (e.g., retrieved contents 512) across modalities. The retrieved contents 512 can be selected and/or determined based on the distance between their feature vectors and the feature vector of the query 502. A predetermined number (e.g., 5 or another number) of nearest neighbors are selected/determined as the retrieved contents 512. However, the assets (images, videos, etc.) themselves and not their feature vectors are fed to the LLM 500 and if the LLM 500 needs feature vectors or embeddings to process them, the LLM 500 can use its own internal mechanisms to convert the asset(s) to feature vectors.

The vector database 510 can comprise features vectors of popular and/or exceptionally popular images. The LLM 500 can detect and/or determine the differences between the input content and the retrieved contents 512 to produce a response 520 that summarizes recommendations to change, modify, and/or enhance an input image. This model may be iteratively improved through feedback loops.

System and method 50 can run on one or more computers 570. The computer(s) 570 can be the same as or different than the computer(s) 470 and/or the computer(s) 270.

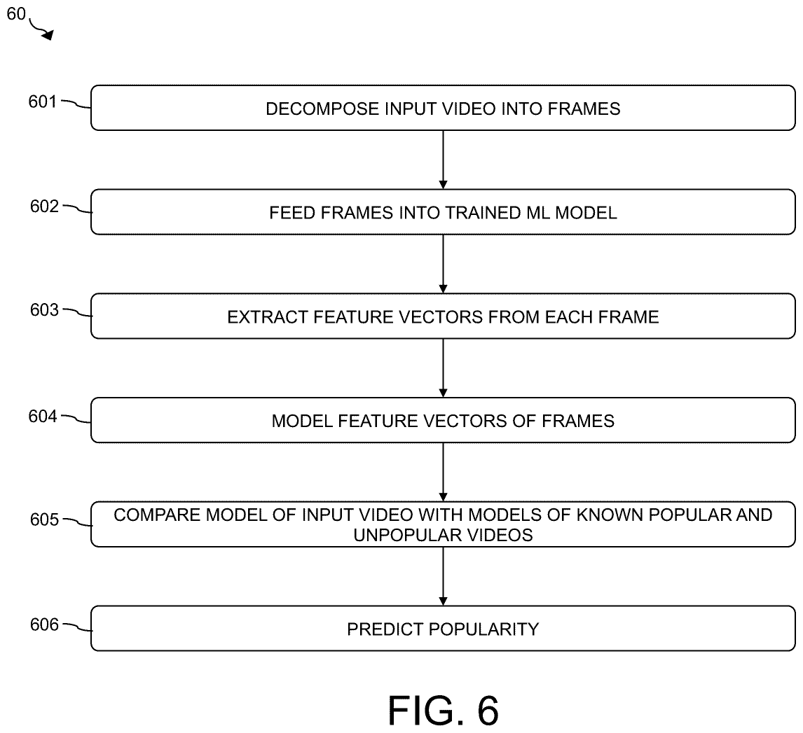

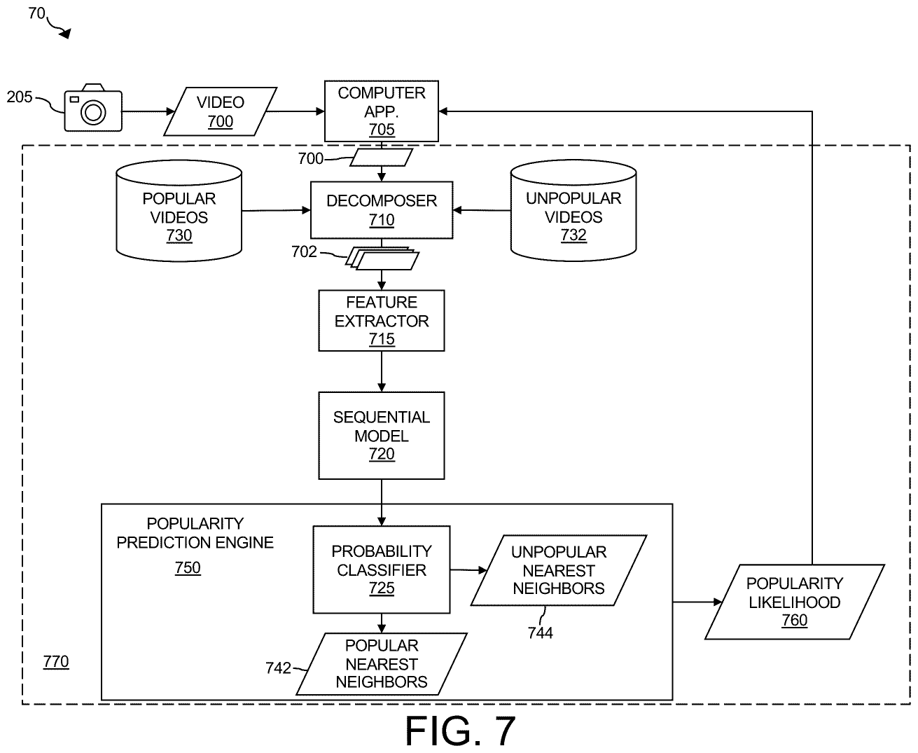

FIG. 6 is a flow chart of a computer-implemented method 60 for estimating a popularity likelihood of unposted sequential content before the sequential content is posted onto a social media platform according to one or more embodiments. Method 60 can be performed using system 70 shown in FIG. 7.

In step 601, an input video 700 is provided to a decomposer 710 that is configured to decompose or subdivide the input video 700 into a plurality of temporally sequenced frames 702. Additionally or alternatively, the decomposer 710 can decompose or subdivide the input video 700 into sequential snapshots and/or sequential scenes. Examples of input video include traditional video images, animations (e.g., clips and/or sequences), animated GIFs (Graphic Interchange Format), and/or other sequential visual images. The input video 700 can be captured using a digital camera 205 such as a webcam, a smartphone, or another digital camera. Additionally or alternatively, the input video 700 can be created, generated, and/or edited using a computer. The decomposer 710 can run on one or more computers 770. The computer(s) 770 can be the same as or different than the computer(s) 270, 470, and/or 570.

The input video 700 can be uploaded or provided to the decomposer 710 using a computer application 705. The computer application 705 can include a web browser or another application running on a computer (e.g., a smartphone or another computer such as a laptop, a desktop, a tablet, etc.). The computer application 705 can be the same as or different than the computer application 220. The input video 700 can alternately be referred to as an unposted video (e.g., that has not been posted to a social media platform).

In one or more embodiments, the decomposer 710 can also decompose or subdivide a plurality of known popular videos 730 and a plurality of known unpopular videos 732 into respective frames 702. The known popular videos 730 have a detrended popularity in the upper 50th percentile including the 60th percentile, the 70th percentile, the 80th percentile, the 90th percentile, or any value or range between any two of the foregoing values. In one or more embodiments, the known popular images 230 having a detrended popularity in the 90th percentile or higher (e.g., 90th percentile to 99th percentile including or any value or range between any two of the foregoing values) can be referred to as known exceptionally popular videos. A detrended popularity accounts for the number of followers of the person or people (e.g., social media account(s)) that posted the known popular videos 730. The known unpopular images 732 have a detrended popularity in the lower 50th percentile including the 40th percentile, the 30th percentile, the 20th percentile, the 10th percentile, or any value or range between any two of the foregoing values. The known popular videos 730 and the known unpopular videos 732 can be stored in the same or separate non-volatile computer memory, such as in a database, in the computer(s) 770.

In step 602, the frames 702 of the input video 700 are fed into a trained ML model that is configured to extract features (e.g., feature vectors) from each frame 702. The trained ML model can comprise a feature extractor 715. The feature extractor 715 can be the same or different than the feature extractor 210. Examples of the feature extractor 715 and/or the trained ML model can include a convolutional neural network (CNN) and/or a recurrent CNN (RCNN) such as ResNet 50, ResNet 100, VGG 16, VGG 19, EfficientNet, Clip, or another CNN/RCNN. A trained ML model other than a CNN/RCNN can be used in some embodiments. The feature extractor 715 can run on the computer(s) 770.

The feature extractor 715 is also configured to extract features (e.g., feature vectors) from the known popular videos 730 and from the known unpopular videos 732.

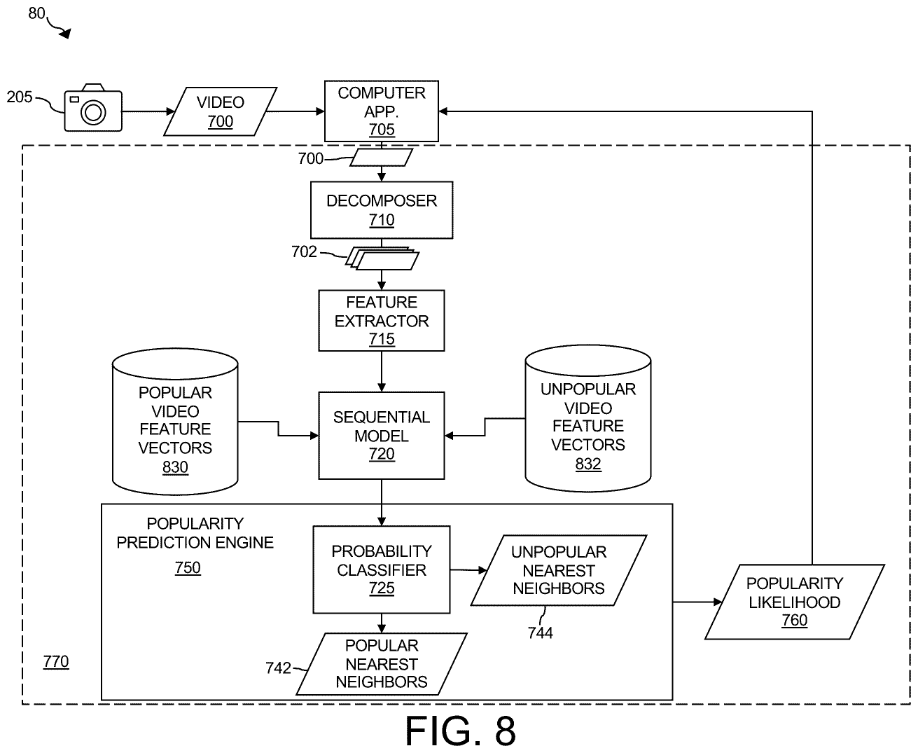

In step 603, feature vectors of the frames 702 of the input video 700, of the known popular videos 730, and of the known unpopular videos 732 are extracted using the feature extractor 715. Alternatively, the frames 702 of the known popular videos 730 and the known unpopular videos 732 can be decomposed and extracted previously, as shown in system 80 in FIG. 8. System 80 is the same as system 70 except that the known popular videos 730 and the known unpopular videos 732 in system 70 are preprocessed by the decomposer 710 (or another decomposer) and the feature extractor 715 (or another feature extractor). Thus, system 80 includes known popular video feature vectors 830 and known unpopular video feature vectors 832 instead of known popular videos 730 and known unpopular videos 732, respectively. The known popular video feature vectors 830 and known unpopular video feature vectors 832 are coupled to the input of the sequential model 720. The known popular video feature vectors 830 and known unpopular video feature vectors 832 can be stored in the same or different non-volatile memory in the computer(s) 770.

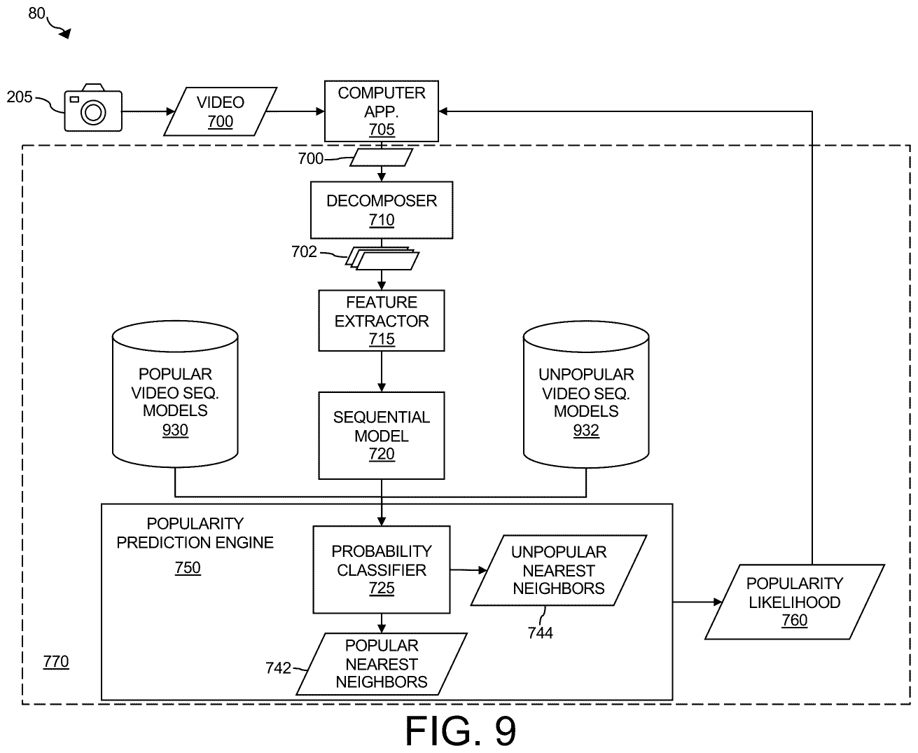

In step 604, a sequential model 720 is used to model the sequence of the frames 702 and their respective feature vectors. A respective sequential model 720 is created for the input video, for each known popular video 730, and for each known unpopular video 732. The sequential model 720 can run on the computer(s) 770. Alternatively, sequential models 930, 932 of the known popular videos and of the known unpopular videos, respectively, can be created previously (e.g., preprocessed), for example as shown in FIG. 9. The sequential models 930, 932 can be stored in the same or different non-volatile memory in the computer(s) 770.

In an aspect, when the input data are sequential, for example, when they are videos comprising a temporal sequence of frames of still images, or music, which is a temporal sequence of sounds, the present system and method can use various machine learning methods (e.g., a sequential model 720) for processing sequential data, such as Long Short-Term Memory Neural Networks (LSTMs) or Recurrent Convolutional Neural Networks (RCNNs or RNN-CNNs) to learn to classify content as popular or unpopular and to derive the probability of sequential data becoming popular. In an embodiment, the sequential data are decomposed into their temporal components and are fed to the machine learning model along with the label for the data (e.g., popular/unpopular). The temporal components of the content can be converted into feature(s) and/or feature vector(s) when fed to the machine learning model using pretrained feature extraction models such as ResNet 50 or Clip, or the feature extraction can be learned along with the structure of the model from data. The whole sequential content is summarized by a feature vector followed by a probability classifier such as Softmax that yields an estimate of the probability of the popularity of the content. A training method such as Backpropagation Through Time (BPTT) or Real-Time Recurrent Learning (RTRL) and Stochastic Gradient Descent (SGD) can be used to learn the classification task and probability of popularity estimation/prediction task.

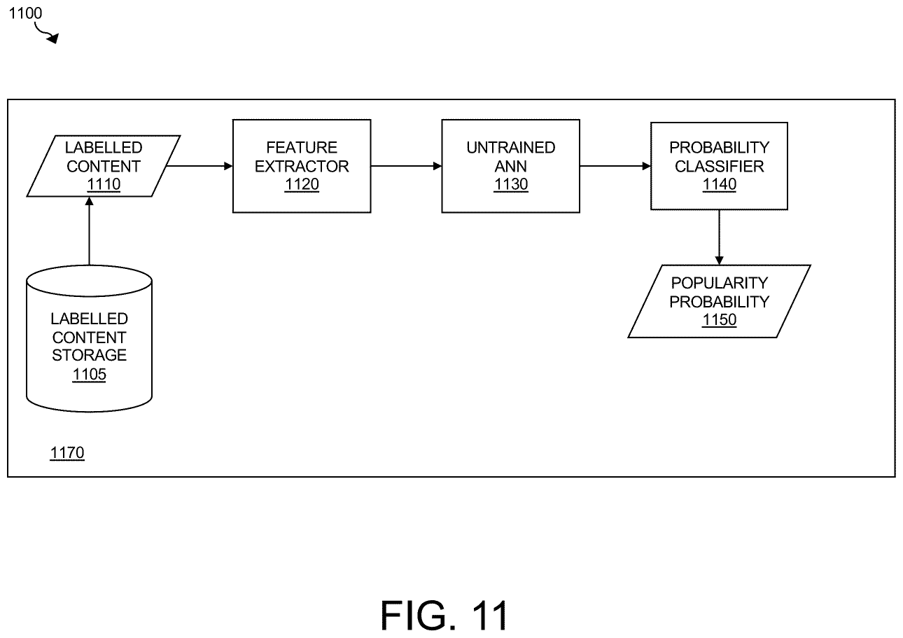

In step 605, the sequential models 720 are compared with a probability classifier 725 such as Softmax to determine the likelihood that the sequential model 720 is similar to one or more known popular videos 730 and thus will likely to be popular when posted on a social media platform. The probability classifier 725 can be previously trained. For example, the probability classifier 725 can be the same as the probability classifier 1140 (FIG. 11). The probability classifier 725 can run on the computer(s) 770.

In one or more embodiments, the probability classifier 725 can identify and/or determine a predetermined number (e.g., K) of nearest neighbors of the input video 700 determined. The probability classifier 725 can include and/or implement a KNN model that can compare the sequential model 720 of the input video frames to the sequential models of the known popular videos 730 and of the known unpopular videos 732. The output of the probability classifier 725 can include a number N of known popular video nearest neighbors 742 and a number M of known unpopular image nearest neighbors 744. The KNN can be implemented using a cosine similarity score according to Equation 1.

In step 606, a predicted popularity likelihood 760 of the input video 700 is determined. The predicted popularity likelihood 760 can be based, at least in part, on the number of the number N of known popular video nearest neighbors 742 relative to the predetermined number (e.g., K) of the nearest neighbors that were determined in step 604. For example, the predicted popularity likelihood 760 can be determined according to Equation 2.

The predicted popularity likelihood 760 can be calculated using a popularity prediction engine 750. The popularity prediction engine 750 can include the probability classifier 725 or can be separate from the probability classifier 725. The popularity likelihood 760 can be provided to the user that provided the input video 700, for example by sending the predicted popularity likelihood 760 back to the computer application 705. Additionally or alternatively, the predicted popularity likelihood 760 can be provided to the user through email, text message, an alert, a pop-up, and/or other electronic communication means. The predicted popularity likelihood 760 can be provided numerically (e.g., as the percentage calculated in Equation 2) or as a binary “popular” or “unpopular.” The input video 700 can be classified as popular when the predicted popularity likelihood calculated in Equation 2 is more than 50% (e.g., 51% to 100%), e.g. if most of the nearest neighbors are known popular videos 730. The input video 700 can be classified as unpopular when the predicted popularity likelihood is less than or equal to 50% (e.g., 0% to 500%) e.g. if most of the nearest neighbors are known unpopular videos 732.

Though method 60 and system 70 are described with respect to an input video 700, known popular videos 730, and known unpopular videos 732, it is recognized that method 60 and system 70 can be used to determine a predicted popularity likelihood of other sequential media content such as audio. Thus, the input video 700 can be replaced with an input audio file or clip, known popular videos 730 can be replaced with known popular audio files/clips, and known unpopular videos 732 can be replaced with known unpopular audio files/clips. Similarly, the input video 700, the known popular video feature vectors 830 and known unpopular video feature vectors 832 shown in FIG. 8 can be replaced with an input audio file or clip, known popular audio feature vectors, and known unpopular audio feature vectors, respectively. In a more general sense, the references to “video” with respect to FIGS. 6-8 can be replaced with “audio file/clip” or “sequential media file/clip.”

The input video 200, the known popular videos 730, and the known unpopular videos 732 can be of the same video type. For example, input video 200, the known popular videos 730, and the known unpopular videos 732 can all be traditional videos or can all be animations.

As described above, a multimodal LLM can be prompted to yield recommendations for enhancement of each subsequence of the input content (for example, each scene of an input video) by comparing it to those K nearest neighbor subsequences, for example as shown in FIGS. 4 and 5.

The recommendations from this technique can therefore be applied to the input content by producing it again, editing it, or using generative AI for applying them. The metric or score for likelihood of popularity of a new piece of content can be used to determine whether the recommendations increase the estimated likelihood of popularity of the content, and if not, enhancement can be done iteratively until the desired results are obtained.

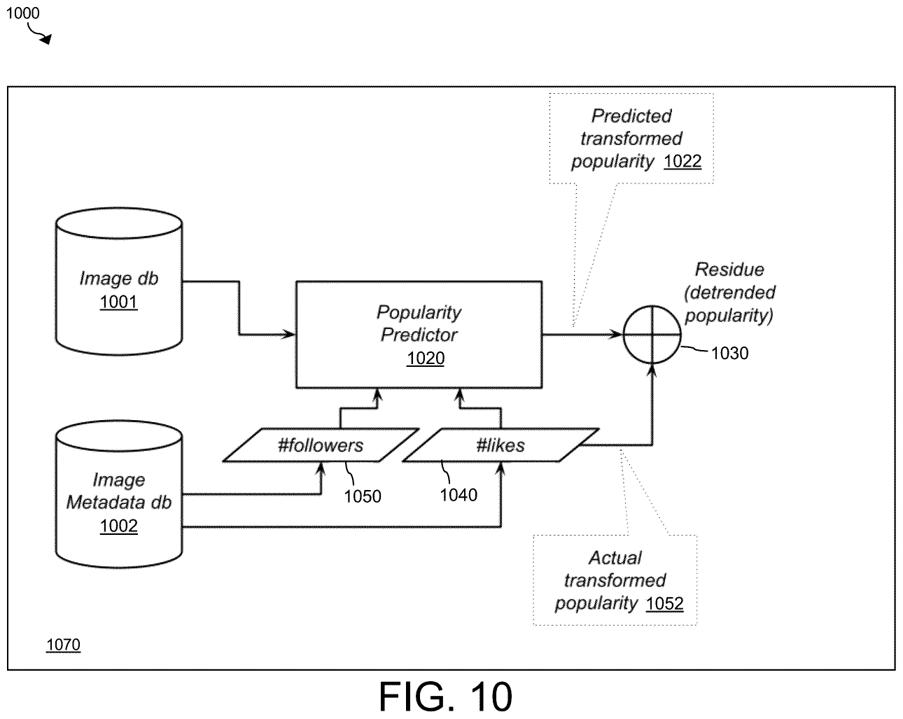

FIG. 10 is a block diagram of a system and method 1000 for determining a detrended popularity of content on a social media platform(s). The detrended popularity can be referred to as an intrinsic popularity. The system and method 1000 can run on one or more computers 1070. The computer(s) 1070 can be the same as the computer(s) 270, 470, 570, and/or 770.

First, the popularity (Y) and the transformed popularity g(Y) of a content is modeled in a popularity predictor 1020 a function of profile-specific variables Xᵢ such as number of followers, number of followees, number of posts, etc., is made, which is denoted by said profile-specific variables X₁, X₂, . . . , Xₚ for example:

$$g ( Y ) = f ( {X}_{1} , {X}_{2} , ... , {X}_{p} ) + ϵ \qquad ( 3 )$$

In Equation 3, ƒ(X₁, X₂, . . . , Xₚ) is the conditional expectation of g(Y) given the independent variables (also called the regression function in the minimum mean-square sense) and e is a zero-mean random variable that models the portion of Y that cannot be modeled using X₁, X₂, . . . , Xₚ. g(Y) can be any function of Y including the identity function g(Y)=Y·g(Y) is the dependent variable in the above equation, and we call it the transformed popularity if g(Y) is a monotonic function such as log(Y). ∈ represents a random noise variable that can be used to model discrepancies. The foregoing are just examples of transformations that can be applied to the popularity Y and other transformation functions g can be used as well.

The modeling employs a dataset that has exemplars of content (e.g., in image database 1001), with metadata (e.g., from an image metadata database 1002) including the popularity (e.g., likes 1040) of the content as well as the publisher-specific features of the content, such as the number of followers 1050. In an aspect, the popularity predictor 1020 uses machine learning methods such as linear regression, random forests, or neural networks to estimate g(Y) as ĝ(Y) based on X₁, X₂, . . . , Xₚ and defines a transformed popularity function (Equation 4):

$$\hat{g} ( Y ) = \hat{f} ( {X}_{1} , {X}_{2} , ... , {X}_{p} ) \qquad ( 4 )$$

where \hat{ƒ}(⋅) is the estimate of ƒ(⋅) provided by the machine learning model. Equation 4 is issued to determine a predicted transformed popularity 1022.

The transformed popularity ĝ(Yᵢ) of the i^{th} content (for example, i^{th} image or video) in our dataset can be predicted (estimated) using the profile-specific features of its publisher Xᵢ₁, Xᵢ₂, . . . , Xᵢₚ as shown in Equation 5.

$$\hat{g} ( {Y}_{i} ) = \hat{f} ( {X}_{i 1} , {X}_{i 2} , ... , {X}_{ip} ) \qquad ( 5 )$$

Once \hat{ƒ} is estimated from data, the discrepancy between g(Y) and the estimated ĝ(Y) can for each piece of content can be calculated according to Equation 6.

$${e}_{i} = g ( {Y}_{i} ) - \hat{g} ( {Y}_{i} ) \qquad ( 6 )$$

In Equation 6, eᵢ is the i^{th} residue, which signifies the amount of transformed or detrended popularity 1030 of content i that cannot be explained by the profile-specific features of the publisher. If eᵢ is positive/negative, it means the content is more/less popular than expected for reasons beyond the profile-specific features of the publisher. It is only reasonable to assume that eᵢ contains information about intrinsic popularity of the content.

In an embodiment of the above method, the log number of likes 1040 versus the log number of followers 1050 may be modeled according to Equation 7.

$$log ( likes ) = {β}_{0} + {β}_{1} log ( followers ) + ϵ \qquad ( 7 )$$

The log transformation of the popularity measure (number of likes 1040) as the dependent variable, and the log of the number of followers 1050 of the profile that published the content on a social media platform such as Instagram is the independent variable in Equation 7. The number of likes 1040 and the number of followers 1050 are metadata that can be included in the image metadata database 1002.

For a given piece content with index i, the parameters [symbol] and [symbol] can be estimated from data using the Ordinary Least-Squares (OLS) method to determine a predicted transformed popularity 1022 based on the number of likes and followers for content i according to Equation 8.

$$log = + \times log {followers}_{i} \qquad ( 8 )$$

There is a discrepancy between the true/actual transformed popularity 1052 of each content (i.e. the log of its number of likes) in the dataset and its popularity estimated/predicted 1022 based on the number of the followers, which is calculated as

$${e}_{i} = log {likes}_{i} - lo {s}_{l} \qquad ( 9 )$$

The residue eᵢ can be viewed as the detrended measure of popularity 1030 of a piece of content, because it is the difference between the log likes that it actually received, and the expected log likes (transformed popularity) predicted by the number of followers.

Published content (e.g., images, sequential content) can be labelled with a respective quantified detrended popularity metric 1030 for use in predicting the popularity of new input/unpublished content.

FIG. 11 is a block diagram of a system and method 1100 for training a model to predict a popularity likelihood of input content (e.g., an input image or input sequential content). The system and method 1100 can run on one or more computers 1170. The computer(s) 1170 can be the same as the computer(s) 270, 470, 570, 770, and/or 1070.

A labelled input content 1110 is provided as an input to a feature extractor 1120. The feature extractor 1120 includes a pretrained deep learning model that is trained on a large image dataset (e.g., ResNet 50, ResNet 100, VGG 16, VGG 19, EfficientNet, Clip, and/or others) to extract features (e.g., feature vectors) from the labelled input content 1110. The labelled input content 1110 can be retrieved from a labelled content storage device 1105 that includes a plurality of labelled input contents 1110.

The labelled input content 1110 is labelled with a detrended popularity metric. The detrended popularity metric can include a qualitative metric (e.g., a label such as popular or unpopular) and/or a quantitative metric (e.g., a popularity percentile such as relative to other content). The labelled input content 1110 is either a known popular content (e.g., a known popular image 230 (FIG. 2) or a known popular video 730 (FIG. 7) (or other known popular sequential content)) or a known unpopular content (e.g., a known unpopular image 232 (FIG. 2) or a known unpopular video 732 (FIG. 7) (or other known unpopular sequential content)). When the labelled input content 1110 is or includes sequential content, the feature extractor 1120 can decompose the sequential content into frames and then extract features/feature vectors of the frames.

An output of the feature extractor 1120 is coupled to an input of an untrained artificial neural network (ANN) 1130. The untrained artificial neural network (ANN) 1130 can include or can be a multilayer perceptron in one or more embodiments. The feature vectors and the labels of the labelled input content 1110 are used to train the untrained ANN 1130. Examples of training include stochastic gradient descent to predict the probability that each image is popular (or unpopular). This makes sure that we transfer the knowledge in features learned from a large image dataset to our application and tailor it to recognize highly popular images.

A probability classifier 1140 is configured to estimate of the popularity probability 1150 of the input content using the feature vector(s) output from the trained ANN. In an example, the probability classifier 1140 includes or is Softmax.

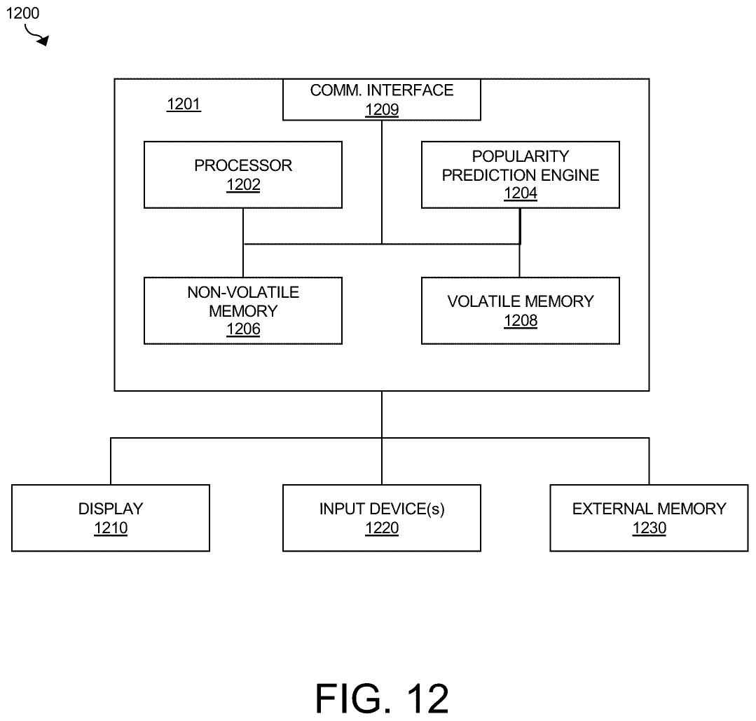

FIG. 12 is a block diagram of a computer system 1200 according to one or more embodiments. The computer system 1200 can be the same as one of the computer(s) 270, 470, 570, 770, 1070, and/or 1170.

The computer system 1200 includes a computer 1201, an optional display 1210, one or more optional input devices 1220, and an optional external memory 1230.

The computer 1201 includes a processor circuit 1202. The processor circuit 1202 can include one or more microprocessors, central processing units (CPUs), graphics processing units (GPUs), and/or other hardware processor circuits. The computer 1201 can also include a popularity prediction engine 1204 that can be configured to perform one, some, or all steps of one or more of the methods described herein. For example, the popularity prediction engine 1204 can be configured to perform one, some, or all steps of method 10, method 60, system and method 1000, and/or system and method 1100.

The computer 1201 also includes non-volatile computer memory 1206 and volatile computer memory 1208. The non-volatile memory 1206 and/or the volatile memory 1208 can store computer-readable instructions for performing one or more of the methods described herein. The non-volatile memory 1206 and/or the volatile memory 1208 can store one or more trained ML models, known popular images (e.g., known popular images 230), known unpopular images (e.g., known unpopular images 232), known popular image feature vectors (e.g., known popular image feature vectors 330, 510), known unpopular image feature vectors (e.g., known unpopular image feature vectors 332), exceptionally popular images (e.g., exceptionally popular images 430), known popular videos (e.g., known popular videos 730), known unpopular videos (e.g., known unpopular videos 732), known popular video feature vectors (e.g., known popular video feature vectors 830), known unpopular video feature vectors (e.g., known unpopular video feature vectors 832), known popular video sequential models (e.g., known popular video sequential models 930), known unpopular video sequential models (e.g., known unpopular video sequential models 932), images (e.g., image database 1001), image metadata (e.g., image metadata database 1002), labelled input content (e.g., labelled input content 1110), and/or other data and/or models.

The processor 1202, the popularity prediction engine 1204, the non-volatile memory 1206, and the volatile memory 1208 are in electrical communication with one another. A communication interface 1209 can wired and/or wireless communication interfaces that allow the computer 1201 (e.g., the processor 1202, the popularity prediction engine 1204, the non-volatile memory 1206, and the volatile memory 1208) to be in network communication with one or more other computers and/or devices. For example, the communication interface 1209 can allow the computer 1201 to be in network communication with other computers that are the same as or different than the computer 1201. In addition, the communication interface 1209 can allow the computer 1201 to receive data, such as an input image 200 and/or an input video 700, from another device or computer operated by a user.

The optional display 1210 is electrically coupled to the computer 1201. The computer 1201 can cause the display 1210 to display graphics and/or text relating to the methods described herein. The computer 1201 can further cause the display 1210 to display a user interface, such as a graphical user interface, that allows a user to interact with the computer 1201 using one or more optional input device(s) 1220, which can include a mouse, a keyboard, a touchscreen, and/or other computer input devices.

The optional external memory 1230 can include a computer program product such as a non-transitory computer readable storage media. The external memory 1230 can store computer-readable instructions that cause the computer 1201 to perform one or more methods or one or more steps of the methods described herein (e.g., methods 10, 60). Thus, the computer-readable instructions can be stored in non-volatile computer memory 1206, the volatile computer memory 1208, and/or in external memory 1230. The external memory 1230 can also store images, video, data and/or models, which can the same as or different than those described above with respect to the non-volatile memory 1206 and/or the volatile memory 1208.

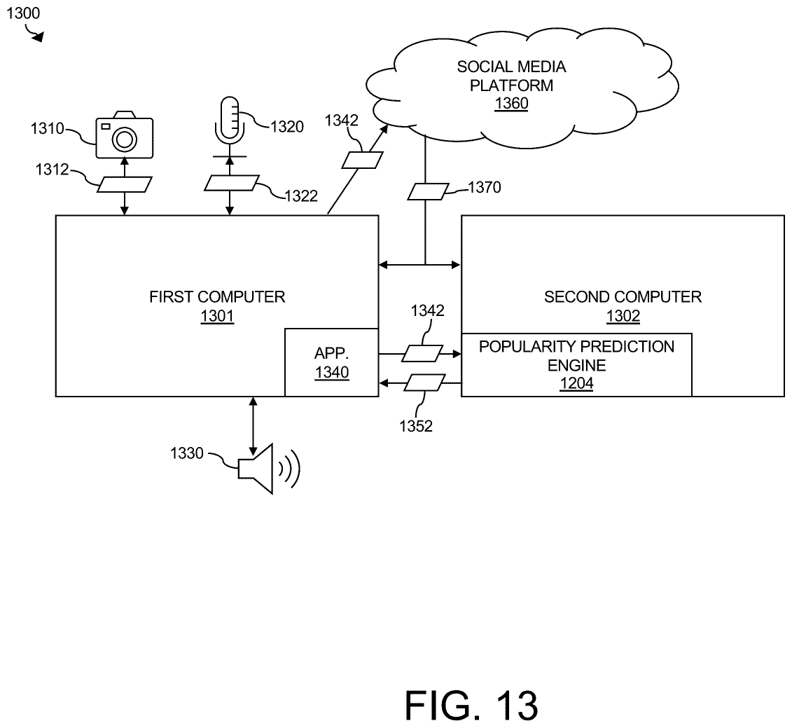

FIG. 13 is a block diagram of a computer system 1300 according to one or more embodiments. The computer system 1300 includes a first computer 1301 and a second computer 1302. Each computer 1301, 1302 can be the same as or different than the computer 1201 and/or the computer system 1200. In an example, the first computer 1301 can be the same as the computer 1201 and/or the computer system 1200 but the first computer 1301 includes a popularity predictor application 1340 instead of the popularity prediction engine 1204.

The first computer 1301 is coupled to, in communication with, and/or includes a digital camera 1310 and/or a digital microphone 1320. The digital camera 1310 can be the same as or different than the camera 205. The digital camera 1310 is configured to capture and/or acquire digital images (e.g., digital image files) and/or digital videos (e.g., digital video files) 1312 suited for display on a display (e.g., display 1210 (FIG. 12). The digital microphone 1320 is configured to capture and/or acquire digital audio (e.g., digital audio files) 1322 suited to play and/or broadcast on one or more speakers 1330 coupled to, in communication with, and/or included in the first computer 1301.

A popularity predictor application 1340 runs on the first computer 1301. The popularity predictor application 1340 is configured to send a digital content file 1342 to the second computer 1302 to determine and/or estimate the popularity likelihood of the digital content file 1342 on a social media platform. The digital content file 1342 can be a digital image and/or digital video 1312 or a digital audio 1322.

The second computer 1302 includes a popularity prediction engine 1204 (e.g., on non-volatile computer memory 1206 (FIG. 12) that can be configured to perform one, some, or all steps of one or more of the methods described herein. For example, the popularity prediction engine 1204 can be configured to perform one, some, or all steps of method 10, method 60, system and method 1000, and/or system and method 1100. The popularity prediction engine 1204 is configured to determine and/or estimate the popularity likelihood of digital content on a social media platform. The non-volatile memory of the second computer 1302 can store can store one or more trained ML models, known popular images (e.g., known popular images 230), known unpopular images (e.g., known unpopular images 232), known popular image feature vectors (e.g., known popular image feature vectors 330, 510), known unpopular image feature vectors (e.g., known unpopular image feature vectors 332), exceptionally popular images (e.g., exceptionally popular images 430), known popular videos (e.g., known popular videos 730), known unpopular videos (e.g., known unpopular videos 732), known popular video feature vectors (e.g., known popular video feature vectors 830), known unpopular video feature vectors (e.g., known unpopular video feature vectors 832), known popular video sequential models (e.g., known popular video sequential models 930), known unpopular video sequential models (e.g., known unpopular video sequential models 932), images (e.g., image database 1001), image metadata (e.g., image metadata database 1002), labelled input content (e.g., labelled input content 1110), and/or other data and/or models.

After the popularity prediction engine 1204 determines and/or estimates the popularity likelihood of the digital content file 1342, the popularity prediction engine 1204 sends data representing a popularity likelihood 1352 of the digital content file 1342 to the first computer 1301 (e.g., to the popularity predictor application 1340) to be visually and/or audibly communicated to the user of the first computer 1301, such as over a display 1210 (FIG. 12) and/or the speaker(s) 1330. The popularity likelihood 1352 can be provided as a quantitative value or range (e.g., 75% likely to be popular) and/or as a qualitative value (e.g., yes/no, highly likely, likely, not likely, or highly unlikely). Recommendations (e.g., recommendations 450) to improve the popularity likelihood 1352 can also be provided, as described herein, from the popularity prediction engine 1204 to the popularity predictor application 1340.

In one or more embodiments, the user of the first computer 1301 can post the digital content file 1342 or a recommended modification thereof to his/her account on a social media platform 1360 and receive actual popularity metrics (e.g., likes/views). The actual popularity metrics 1370 can be provided as feedback to the popularity prediction engine 1204, such that the second computer 1302 can make one or more adjustments to the popularity prediction engine 1204 when the difference between the popularity likelihood 1352 and the actual popularity metrics 1370 is greater than a predetermined value (e.g., 10-20%).

In one example, the actual popularity metrics 1370 are provided from the social media platform 1360 to the first computer 1301, and then the first computer 1301 (e.g., using the popularity predictor application 1340) sends the actual popularity metrics 1370 to the popularity prediction engine 1204 on the second computer 1302. In another example, the actual popularity metrics 1370 are provided from the social media platform 1360 to the second computer 1302 and/or to the popularity prediction engine 1204 on the second computer 1302. For example, the user of the first computer 1301 can provide his/her user credentials to the popularity prediction engine 1204 to retrieve/access the actual popularity metrics 1370 on the user's account. In another example, the actual popularity metrics 1370 are publicly available, such as in Twitter (k/n/a “X”) or Bluesky.

Aspects of the invention provide a technical solution to a technical problem. One technical problem that is solved by at least some aspects of the invention is predicting the popularity likelihood of unposted digital content before such content is posted onto a social media platform. The technical problem is overcome by comparing multidimensional feature vectors of unposted digital content with multidimensional feature vectors of known popular and unpopular content. It would be impossible to compare multidimensional feature vectors in a human's mind.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A computer-implemented method for estimating a popularity likelihood of an input image before the input image is posted onto a social media platform, the method comprising:
feeding the input image into a trained machine learning (ML) model running on a computer, the trained ML model configured to extract a plurality of feature vectors from the input image;
extracting, with the trained ML model, the feature vectors from the input image;
identifying, using the feature vectors and a similarity calculator running on the computer, a predetermined number of nearest neighbors of sample images, the sample images having a known detrended popularity metric, the sample images including known popular images having a known detrended popularity percentile that is greater than a 50th percentile and known unpopular images where the known detrended popularity percentile is less than or equal to the 50th percentile; and
predicting, with the computer, the popularity likelihood of the input image based, at least in part, on a number of the nearest neighbors that are known popular images relative to the predetermined number of the nearest neighbors.

2. The method of claim 1, wherein the popularity likelihood is determined as a ratio of the number of the nearest neighbors that are known popular images relative to the predetermined number of the nearest neighbors.

3. The method of claim 1, wherein the similarity calculator includes as inputs the feature vectors of the input image and feature vectors of the sample images.

4. The method of claim 3, further comprising:
feeding the sample images into the trained ML model; and
extracting, with the trained ML model, the feature vectors of the sample images from the sample images.

5. The method of claim 3, further comprising:
comparing, with a large language model (LLM), the feature vectors of the input image and the feature vectors of the known popular images; and
producing, with the LLM, recommendations based on the comparison.

6. The method of claim 5, wherein the recommendations include narrative text that describes one or more recommended changes to the input image.

7. The method of claim 5, wherein the recommendations include a new image that includes one or more recommended changes to the input image.

8. The method of claim 1, wherein:
the computer is a first computer, and
the method further comprises receiving the input image from a second computer in network communication with the first computer.

9. The method of claim 1, further comprising capturing the input image with a camera coupled to and/or in communication with the second computer.

10. A computer-implemented method for estimating a popularity likelihood of a sequential input content before the sequential input content is posted onto a social media platform, the method comprising:
with a decomposer running on a computer, decomposing the sequential input content into a plurality of frames;
feeding the frames into a trained machine learning (ML) model running on the computer, the trained ML model configured to extract a plurality of feature vectors from each frame;
extracting, with the trained ML model, the feature vectors from each frame;
applying, with the computer, a sequential model to the feature vectors of the frames; and
predicting, using a probability classifier running on the computer, the popularity likelihood of the sequential input content using the sequential model of the sequential input content and sequential models of a plurality of sequential sample contents, each sequential sample content having a known detrended popularity metric, the sequential sample content including a plurality of known popular sequential contents having a respective known detrended popularity percentile that is greater than a 50th percentile and a plurality of known unpopular sequential contents where the respective known detrended popularity percentile is less than or equal to the 50th percentile.

11. The method of claim 10, wherein the sequential input content comprises a video content or an audio content.

12. The method of claim 10, wherein:
the probability classifier determines a predetermined number of the sequential sample contents as nearest neighbors, and
the popularity likelihood of the sequential input content is based, at least in part, on a number of the nearest neighbors that are known popular sequential content relative to the predetermined number.

13. The method of claim 12, wherein the popularity likelihood is determined as a ratio of the number of the nearest neighbors that are known popular sequential content relative to the predetermined number.

14. The method of claim 13, further comprising:
decomposing, with the decomposer, the sequential sample contents into respective frames;
feeding the respective frames of the sequential sample contents into the trained ML model;
extracting, with the trained ML model, a plurality of feature vectors from each frame of each sequential sample content; and
applying, with the computer, a respective sequential model to the respective feature vectors of the frames for a respective sequential sample content to produce the sequential models.

15. The method of claim 10, wherein:
the computer is a first computer, and
the method further comprises receiving the sequential input content from a second computer in network communication with the first computer.

16. The method of claim 15, wherein:
the sequential input content comprises a video, and
the method further comprises capturing the video with a camera coupled to and/or in communication with the second computer.

17. The method of claim 15, wherein:
the sequential input content comprises an audio file, and
the method further comprises capturing the audio file with a microphone coupled to and/or in communication with the second computer.

18. A system for estimating a popularity likelihood of an image prior to posting the image onto a social media platform, comprising:
a camera configured to capture an input image to be uploaded to the social media platform;
a first computer comprising:
one or more first microprocessors;
a first non-volatile memory operably coupled to the microprocessor(s), the first non-volatile memory storing first computer-readable instructions that when executed by the first microprocessor(s), cause the first microprocessor(s) to run an application for uploading the input image to a popularity predictor;
a second computer comprising:
one or more second microprocessors;
a second non-volatile memory operably coupled to the second microprocessor(s), the second non-volatile memory storing second computer-readable instructions that, when executed by the second microprocessor(s), cause the second microprocessor(s) to:
receive the input image from the application running on the first computer;
feed the input image into a trained machine learning (ML) model that is configured to extract a plurality of feature vectors from the input image;
extract, with the trained ML model, the feature vectors from the input image;
identify, using the feature vectors and a similarity calculator, a predetermined number of nearest neighbors of sample images, the sample images having a known detrended popularity metric, the sample images including known popular images having a known detrended popularity percentile that is greater than a 50th percentile and known unpopular images where the known detrended popularity percentile is less than or equal to the 50th percentile;
predict the popularity likelihood of the input image based, at least in part, on a number of the nearest neighbors that are known popular images relative to the predetermined number of the nearest neighbors; and
send an output representing the popularity likelihood to the application running on the first computer.
